(19) United States
(12) Patent Application Publication
(10) Pub. No.: US 2010/0217824 A1
(43) Pub. Date: Aug. 26, 2010

(54) METHOD AND SYSTEM FOR DELIVERING MEDIA DATA TO A USER'S MOBILE DEVICE

(75) Inventors: Martin Stiemerling, Leimen (DE); Marcus Brunner, Leimen (DE)

Correspondence Address: YOUNG & THOMPSON, 209 Madison Street, Suite 500, Alexandria, VA, 22314, US

(73) Assignee: NEC EUROPE, LTD., Heidelberg (DE)

(21) Appl. No.: 12/600,334

(22) PCT Filed: May 14, 2007
(86) PCT No.: PCT/EP2007/004268

§ 371 Date: Mar. 19, 2010

(51) Int. Cl. G06F 15/16

(52) U.S. Cl. 709/217

(57) ABSTRACT

A method and a system for delivering media data to a user's mobile device, wherein a service control (2) is configured to receive media content related requests from the user's mobile device (1), wherein the service control (2) forwards the user's requests to a network-based media recorder (4), which records media data corresponding to the user's requests, wherein at least one caching element (3) is provided, at which recorded media data is being cached and which allows forwarding of cached media data to the user's mobile device (1), and wherein the service control (2) is further configured to receive information regarding the user's context, wherein the context information is used to control the forwarding of media data recorded by the media recorder (4) to the caching element (3).

The present invention relates to a method and system for delivering media data to a user's mobile device.

Watching TV broadcasts on the move is still in its infancy. There are some portable devices for analogue and digital TV broadcasts, but usually they are quite large and, thus, cumbersome to carry around. Moreover they have limited battery power. The current trend is to integrate TV broadcast capabilities into mobile devices, such as mobile phones or mobile computers. For mobile phones DVB-H, DMB (Digital Media Broadcast, based on DAB), UMTS, and the next generation wireless technologies are envisioned to bring life broadcasts to millions of users. However, all these techniques require a constant connection to the media stream transported by DVB-H, DMB, or related technologies, i.e., the mobile devices must be in the reach of the base stations from which the media stream is being broadcasted or transmitted.

Another important requirement for a smooth reception of multimedia broadcasts on the move is that the above-mentioned techniques are deployed—ideally—everywhere. For people on the move in cities or metro areas this definitely holds true in many cases, since the broadcast coverage is given. For example, a UMTS/next generation wireless coverage is provided, i.e., there is a network point of attachment which is fast enough to support the transmission of multimedia data so that a user can watch TV broadcasts without interruptions (although today, UMTS might not have enough bandwidth for transporting high resolution media content). In general, there are only few spots where the reception conditions are not sufficient. On the other hand, for people on the move in rural areas without broadcast stations supporting the mobile TV techniques (e.g. no base stations supporting DVB-H or DMB) mobile TV reception will not be possible. The same holds true for mobile users with no high speed mobile access (many rural areas only have GPRS) or for passengers in trains passing through many tunnels.

Even though that there are attempts to widen the broadband coverage to many areas, there will be always areas in the future that are not covered by broadcast and mobile wireless broadband coverage. Furthermore, mobile users moving at higher speeds or, for example, in hilly areas will experience issues when trying to receive mobile TV, due to fading effects of the radio channels. This overall situation is very unsatisfactory for mobile users on the move that wish to watch their favorite media content, such as, for instance, a soccer match, a newscast or a movie, when the TV reception is working with interruptions, or when they experience bad signal reception or, in the worst cases, when there is no reception at all. Even when there is wide area broadband wireless access coverage, short-range wireless such as WLAN is less expensive, and allows therefore getting the same content but more cost efficient.

Since the late 1990s content delivery networks, also known as content distribution networks (CDN), have been designed to provide end-users with large amounts of media data. These networks comprise a large number of locally distributed computers which communicate across the Internet. The CDN nodes deployed in multiple locations cooperate with each other to satisfy requests for media content by end-users. The media data is transparently cashed in the network so that the delivery can be performed either very fast (performance optimisation) or in a form of a reduced bandwidth (cost optimisation), or both. However, the media data delivered by means of CDNs, in general, is not very specific and the delivery process is designed to serve the public. On the other hand, individual mobile users who are on the move and who are interested in specific media content generally can not take advantage of the kind of service provided by content distribution networks.

It is therefore an object of the present invention to improve and further develop a method and a system of the initially described type for delivering media data to a user's mobile device in such a way that, by employing mechanisms that are readily to implement, a high level of reliability is achieved for the data delivering process and interruptions for the user are avoided as far as possible.

In accordance with the invention, the aforementioned object is accomplished by a method comprising the features of claim 1. According to this claim a method for delivering media data to a user's mobile device comprises the following features:
a service control is configured to receive media content related requests from the user's mobile device,
the service control forwards the user's requests to a network-based media recorder, which records media data corresponding to the user's requests,
at least one caching means is provided, at which recorded media data is being cached and which allows forwarding of cached media data to the user's mobile device, and
the service control is further configured to receive information regarding the user's context, wherein the context information is used to control the forwarding of media data recorded by the media recorder to the caching means.

Furthermore, the aforementioned object is accomplished by a system comprising the features of claim 17. According to this claim a system for delivering media data to a user's mobile device comprises
a service control, which is configured to receive media content related requests from the user's mobile device,
a network-based media recorder, which is configured to receive the user's requests forwarded to it by the service control and which records media data corresponding to the user's requests, and
at least one caching means for the caching of recorded media data, the caching means being configured to allow forwarding of cached media data to the user's mobile device,
wherein the service control is further configured to receive information regarding the user's context and to control the forwarding of media data recorded by the media recorder to the caching means on the basis of said user's context information.

According to the invention it has first been recognized that for a mobile user interruptions with respect to the reception of media broadcasts on the move can be efficiently avoided by employing caching means and by taking into account context information of the mobile user. The method and the system according to the invention are controlled by a service control which is configured to receive media content related requests from the user's mobile device. The service control forwards the user's requests to a network-based media recorder where media data corresponding to the user's requests are recorded. Recorded media data is being cached at one caching means at least, which is configured to allow forwarding of cached media data to the user's mobile device/terminal.

According to the invention the context information of the user, which is provided to the service control, is used to control the forwarding process of recorded media data to the caching means. By taking into account user specific context information, the method and system according to the invention achieve a high level of personalisation and individualisation which enables an optimized delivery of media data to the user's mobile device. Thus, an uninterrupted consumption of requested media content is possible. In other words, the method and system according to the invention realizes a kind of Disruption Tolerant Network (DTN) with a time shifting functionality which allows users, especially users on the move, to receive high-quality media even though they have no or only an insufficient network connection. They receive the recorded content via an appropriately located caching means when they are able to connect a—preferably high-speed—network link. Consequently, users are enabled to watch their TV programmes, or any other real time media, while not being in the range of mobile TV stations or in bad wireless situations, as, e.g., in high-speed trains passing through many tunnels.

Advantageously, the information regarding the user's context includes information regarding the user's network location and/or the user's geographic location. On the basis of this kind of information, the process of selecting appropriate caching means, from where the media data can be efficiently forwarded to the user's terminal, can be optimized.

Furthermore, the information regarding the user's context may include information regarding the user's intended sojourn in terms of time and location. By providing this information to the service control, the service control is enabled to determine the most appropriate caching process in advance. In other words, if the service control knows the user's planned movement pattern, for example that the user intends to be at location X at the time Y, the service control is enabled to choose a caching means close to location X and can control the forwarding of recorded media data to that caching means prior to time Y. Actually, when the user reaches location X at time Y the requested data the cached media data can be forwarded to the user's mobile device. Actual travel directions of the user may be, for example, read from a car navigation system and may be transmitted to the service control.

In a still further advantageous embodiment, the service control disposes of position based traffic information. This kind of information may include but is not limited to information regarding flight and/or train timetables, train tracks and/or traffic conditions (such as e.g. traffic jam). In such an embodiment the user only has to inform the service control of his intended itinerary and the service control can make use of the position based traffic information in order to control the forwarding process of data to appropriate caching means. For example, if the user informs the service control that he intends to travel from location A to location B by train, with his train leaving the station at location A at time X, the service control can obtain from the train schedules those locations, at which the train passes by at certain times, and can thus optimize the selection of appropriate caching means along the way.

Moreover, network measurements may be performed, the results of which may be used in order to further optimize the process of determining the most appropriated caching means.

Advantageously, the service control is configured to receive information regarding the user's preferences and/or regarding the capabilities of the user's mobile device. This information may include but is not limited to information regarding a minimum video size, a preferred audio quality, the available screen size or available interfaces. Thereby, the delivery of media data to the user's mobile device can be best adapted to the user's individual requirements.

With respect to an individual adaptation to user requirements, it further proofs to be advantageous that the system comprises an encoder and/or transcoder which is enabled to encode and/or transcode media data from one format to another. The encoding/transcoding can be performed before the data are stored by the media recorder. Alternatively, it is possible to record the media data first and encode/transcode the data before the data is being cached at a caching means.

In a further advantageous embodiment, media data which is cached at the caching means and which is not picked up by the user's mobile device is deleted after a pre-configurable time period. A message may be automatically generated by the caching means in order to inform the service control of the deletion. The service control may notify the user who is thereby enabled to decide on sending a new request, for example for receiving the respective media data via another caching means.

In a preferred embodiment a plurality of caching means is provided. The caching means may form part of a fixed network and may be geographically distributed. For example, the caching means may be provided at locations, that are regularly passed by travellers, e.g. at train stations, airports, gas stations, etc. The caching means may be connected to network points which allow attachment of the user's mobile device in order to forward cached media data to the mobile device. The caching means may be—directly or indirectly—connected to any kind of internet access point, such as e.g. a WLAN access router or a WiMAX base station. Cached media data may than be forwarded to the user's mobile device, when the user's mobile device is attached to the respective point of attachment.

In an alternative embodiment at least one caching means may be associated to the user's mobile device in such a way that both the caching means and the user's mobile device perform essentially the same movements. For example, the caching means may be designed as an onboard unit which is mounted in a user's car. In such a case the caching means itself may be filled with requested and recorded media data while being connected in certain locations. Between the user's mobile device and a caching means located onboard a moving vehicle a permanent connection may be realized. This will relieve the users from operating their own cache locally. Operating a cache usually requires an additional amount of terminal memory and processing power, which is typically not a feature for small mobile devices, such as a mobile phone.

The media content requested by the user and stored by the media recorder may be forwarded to a caching means as a single entity. In other words, if the user requests certain media content, e.g. a movie, the movie as a whole may be forwarded to a caching means. However, if this is not possible, the media content requested by the user and stored by the media recorder may be forwarded to a caching means in several chunks. This results in a higher flexibility. For example in the case of a train ride, a movie could be divided in several smaller chunks that are being cached by different caching means located at different train stations along the user's routing. When the user reaches a certain station, the respective chunk can be forwarded to his mobile device via an appropriate network point of attachment. The length of the chunks could be determined according to the distances between single stations at which the user has access to a network point of attachment to transfer cached media data to his terminal. For example, when the travel time between station A and next station B is quite long, the service control may generate a long chunk to be cached at the caching means at station A. When the playing time of the chunk is longer as the travel time between A and B, interruptions for the user on his way from A to B are avoided, before he may receive the next chunk at station B.

With respect to avoiding failures in forwarding cached media data to a user's terminal, it is advantageous that the network between the caching means and the mobile terminal is of higher speed than the network between the media recorder and the caching means. Hence, loading a certain content to a caching means may take longer compared to loading content from the caching means to the mobile device. Due to the high speed, even relatively short connection periods of a user with the network while passing by a point of attachment, for example a short stay at a railway station or a stopover at a fuel station, are sufficiently long to load content from the caching means to the user's mobile device. It is as well possible, to preload data to the caching means for avoiding burst traffic on the network between the media recorder and the caching means even if the network has enough bandwidth. This would help to avoid congestion that might be caused in the network due to the fact that the caching means need to hold media data for more than one user.

There are several ways how to design and further develop the teaching of the present invention in an advantageous way. To this end is to be referred to the patent claims subordinate to independent patent claims 1 and 17 and to the following explanation of examples of preferred embodiments of the invention, illustrated by the figure on the other hand. In connection with the explanation of preferred embodiments of the invention by the aid of the figure, generally preferred embodiments in further developments of the teaching will be explained.

In the drawings:

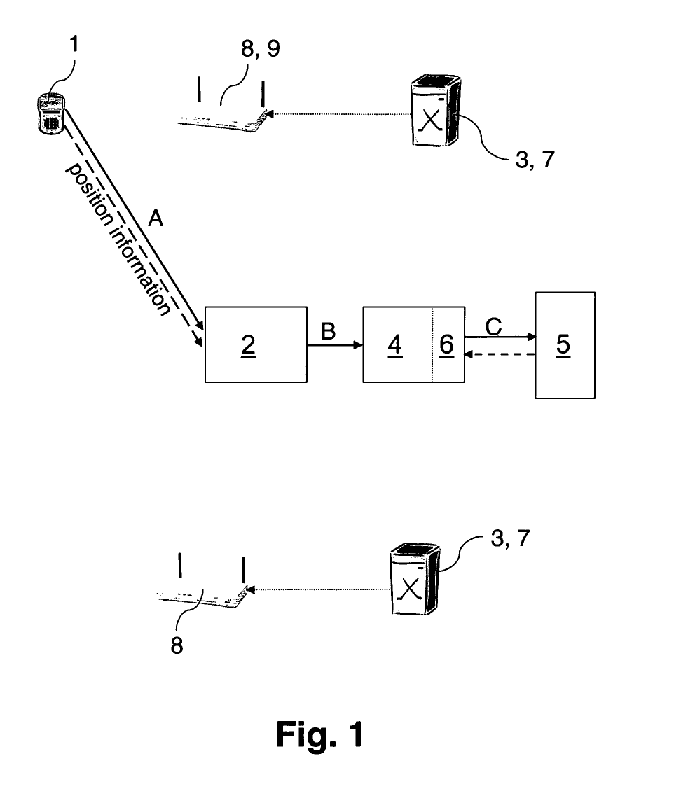

FIG. 1 is a schematic view of a first embodiment of a system according to the invention, showing the process of recording of media data,

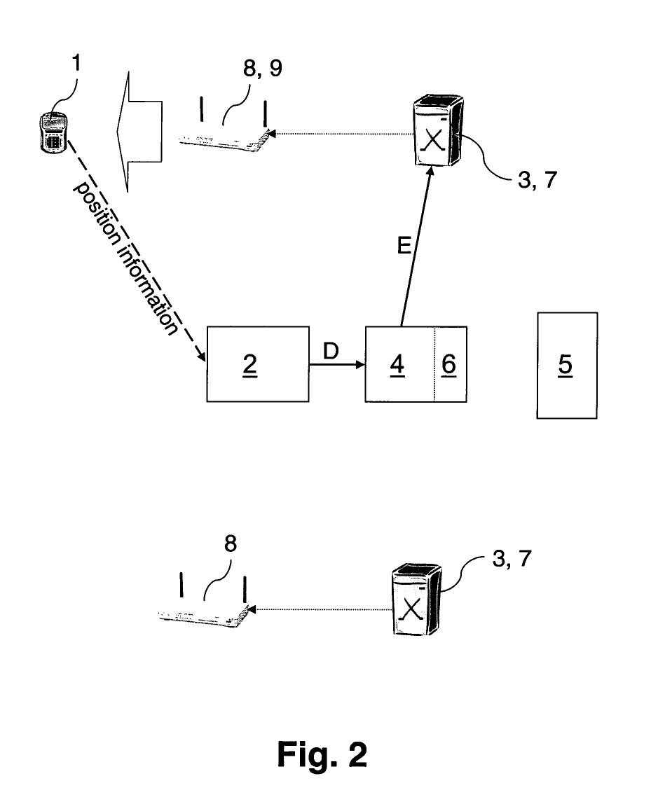

FIG. 2 is a schematic view of the embodiment of FIG. 1, showing the forwarding process of recorded media data,

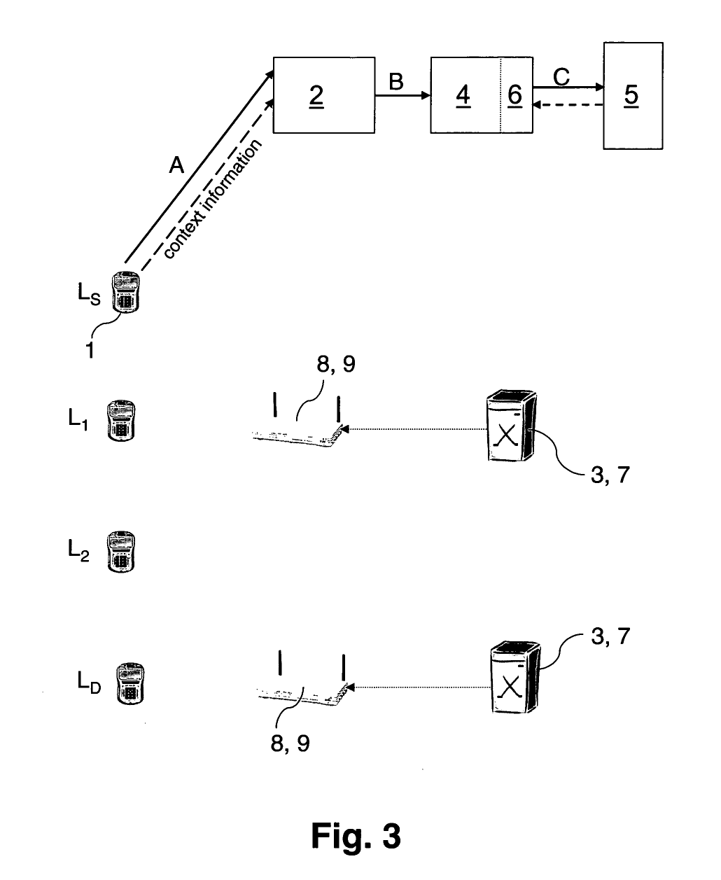

FIG. 3 is a schematic view of a second embodiment of the system according to the invention, showing another application scenario, and

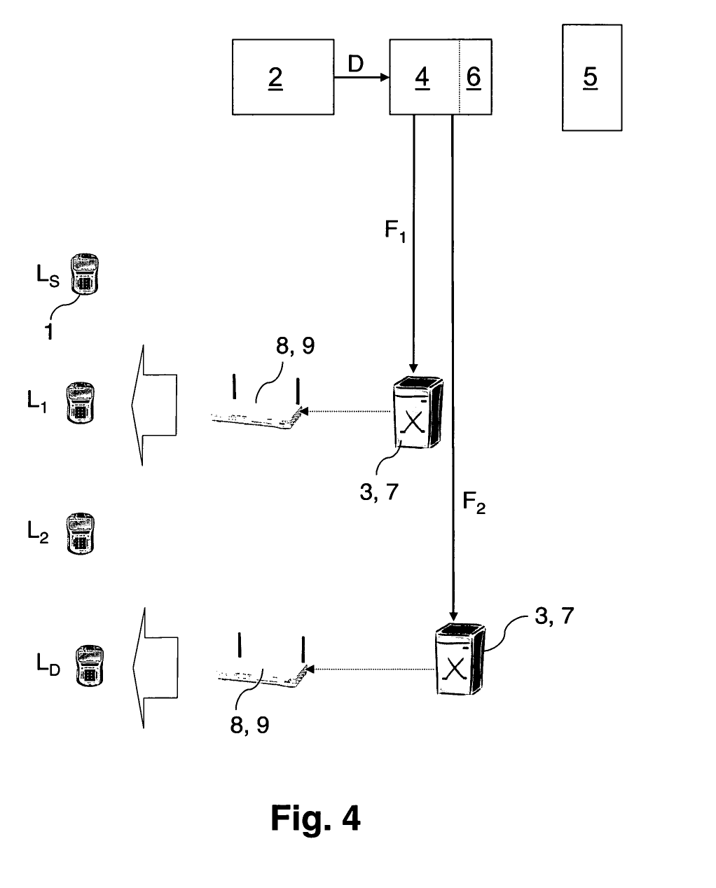

FIG. 4 is a schematic view of the embodiment of FIG. 3, showing again the forwarding process of recorded media data.

FIG. 1 illustrates schematically a first embodiment of the present invention. The system according to the embodiment shown in FIG. 1 comprises the following nodes: A user terminal or mobile device 1, a service control 2, caching means 3 and a network-based media recorder 4. The network-based media recorder 4 is enabled to receive multimedia content in any type from a content source 5. The content source 5 may include, for instance, but is not limited to a media server of a content provider, a cable TV, or a video recorder. The media recorder 4 is able to store multimedia content as used to from video recorders and can play out the content at any given time. The flow of multimedia content from the content source 5 to the network-based media recorder 4 is indicated by the dashed line arrow of FIG. 1.

Additionally, the network-based media recorder 4 of FIG. 1 comprises an encoder/transcoder 6 which is able to encode content or transcode it from one content format to another. However, it is to be understood that the encoder/transcoder 6 may be implemented as a separate unit which is located between the content source 5 and the media recorder 4 to encode/transcode media data before it is being recorded. Alternatively, the encoder/transcoder 6 can be located behind the media recorder 4 to encode/transcode media data before it is forwarded to a caching means 3 as described below.

The system comprises a plurality of caching means 3 designed as disruption tolerant network (DTN) caches 7, which are geographically distributed and which are able to store data, especially multimedia data. For the purpose of clarity only two of them are depicted in FIG. 1.

The operational chain for the system starts with the user's terminal 1 sending a media content related request to the service control 2 as indicated by the arrow labelled A. The service control 2 forwards the request to the network-based media recorder 4, as indicated by arrow labelled B. The media recorder 4 sends an appropriate request (as indicated by arrow C) to the content source 5 and stores the media data, which it receives from the content source 5 (dashed line arrow). The media data to be recorded may include but is not limited to a TV broadcast or a radio broadcast.

The operational chain described above is controlled via the service control 2 which is the central part of the system and which selects the single nodes of the system if multiple choices are available. The service control 2 also decides how the media data is encoded and whether the media data needs to be adapted by the encoder/transcoder 6. Moreover, the decision of where to cache the data is handled in the service control 2.

In the embodiment shown in FIG. 1 the user 1 is not moving and its location is close to the cache 7 that is shown in the upper part of FIG. 1. The position information may be transmitted to the service control 2 either once, which is best suited for static cases in which the user 1 does not change his position for a certain time period. Alternatively, the position information may be updated periodically or each time a change in the user's location occurs. Consequently, as can be obtained from FIG. 2, the service control 2, taking into account the location information about the user's terminal 1, triggers the network-based media recorder 4 (arrow D) to forward to recorded media data to that cache 7 in the upper part of FIG. 2 (arrow E). This cache 7 is connected to a network point of attachment 8 which may be designed as a WLAN access point 9. As soon as the user's terminal 1 is online, i.e. as soon as the user's terminal 1 is attached to the access point 9, the cached media data may be forwarded to the user's terminal 1, which is indicated by the broad arrow. The forwarding may be performed immediately after attachment or upon an explicit user/terminal request.

The content can be forwarded between the single conceptual entities either as a single piece, i.e., a complete movie, or in smaller chunks, e.g., every 30 minutes to get smaller parts of the movie ready before the whole is ending. The DTN cache 7 takes care of storing the content to be received by the terminal 1. If the terminal 1 is online, the cache 7 is just forwarding the media, if the terminal 1 is offline it stores the content until the terminal 1 is back online again.

As indicated by the broad arrow in the embodiment shown in FIG. 2, the network between the cache 7 and the terminal 1 is much higher speed than the network between the media recorder 4 and the cache 7. Therefore, loading a certain content chunk to the cache 7 might take longer compared to loading the content from the cache 7 to the terminal 1. It is as well possible, to preload data to the cache 7 for avoiding burst traffic on the network between media recorder 4 and the cache 7, even if the network has enough bandwidth. This would avoid congestion caused in the network given the fact that the DTN caches 7 need to hold data for more than one user.

FIG. 3 illustrates schematically another embodiment of the present invention, in which the user moves from an initial starting location Lₛ to a final destination location L_{D}. The same components of the system are indicated by the same reference numbers as in FIGS. 1 and 2.

The operational chain for the system again starts with the user's terminal 1 sending a media content related request to the service control 2, as indicated by the arrow labeled A. The service control 2 forwards the request to the network based media recorder 4, as indicated by arrow labeled B. The media recorder 4 sends an appropriate request (as indicated by arrow C) to the content source 5 and stores the media data, which it receives from the content source 5 (indicated by the dashed line arrow).

Furthermore, the user's terminal 1 transmits context information to the service control 2. The user's context information comprises information regarding an intended train ride from the user's home town (location L_{S}) to, e.g., an airport, which is specified as final destination location L_{D}. The context information transmitted to the service control 2 contains a specification of the train the user 1 intends to take, especially the departure time of the train. The service control 2 has access to train time tables and is thus enabled to calculate the user's itinerary, e.g. the points in time at which the user 1 will presumably be at certain locations. Based on these calculations, the service control 2 can perform a prediction of the next best locations (in the network topology) where the user's terminal 1 will be next time well connected to a (high-speed) network link. The service control 2 will notify the media recorder 4 about that place (or places) and will send appropriate commands to the media recorder 4 by which the media recorder 4 is informed to which cache 7 it shall forward certain media content. In detail:

In calculating the user's journey, the service control 2 knows that on the user's way there will be two network links which allow forwarding of media content to the user's terminal 1. The first one is a WLAN access point 9 at location L₁, which is a train station where the train is scheduled to stop for a few minutes. The second one is a WLAN access point 9, which is located at the airport, i.e. the user's final destination location L_{D}. Accordingly, the service control 2 generates command messages which are forwarded to the media recorder (arrow D in FIG. 4) and which instruct the media recorder 4 to divide the requested media content into two chunks. Furthermore, the service control 2 informs the media recorder about the caches 7 to which the single chunks have to be forwarded, as well as about the points in time at which the forwarding of the chunks has to be performed.

As can be obtained from FIG. 4, the first chunk is forwarded to the cache 7 located at location L₁ (as indicated by arrow F₁) and, later on, the second chunk is forwarded to the cache 7 located at the final destination L_{D}. When the train reaches the station (location L₁) and stops there fore a few minutes, the user's terminal 1 can attach to the WLAN access point 9 located at that station and the media data cached at the corresponding DTN cache 7 can be forwarded to the user's terminal. On the user's way from location Lᵢ to the final airport destination L_{D}—this way is, in FIG. 4, indicated as location L₂—there is no possibility for the user's terminal 1 to access a network. However, the user 1 is enabled to consume, e.g. watch and/or listen, the media content which has been forwarded to his terminal at the station L₁. As soon as the user arrives at the airport L_{D} he can go online again and can receive the second chunk of the requested media content.

The forwarding process described until now in a rather general way can be optimized in several ways. For example, in the embodiment shown in FIG. 4, the service control 2 may calculate the length of the first chunk (which is transmitted to the first cache 7 as indicated by the arrow denominated F₁) according to the scheduled traveling time between the station L₁ and the airport L_{D}, where the user has the next possibility to get online. Concretely, the length of the first chunk can be chosen such that the playing time of the chunk on the user's terminal 1 is slightly longer than the traveling time between L₁ and L_{D}. Thus, before the playing time of the first chunk is over, the next chunk can be forwarded to the user's terminal 1 by getting online at the airport L_{D}. Consequently, a consumption of the requested media content without any interruption is insured.

With respect to a further optimization, delays of the train can be taken into account by periodically updating the position information of the user's terminal 1. For example, if the service control 2 is informed, that the station L₁ will be reached with a delay, the transmittal of a media chunk from the media recorder 4 to an appropriate cache 7 may be postponed. In cases, in which the media content is just being recorded by the media recorder 4, this allows opting for a longer chunk, as at the time of the delayed arrival at station L₁, already a longer sequence of the requested media data has been recorded.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for delivering media data to a user's mobile device,
wherein a service control (2) is configured to receive media content related requests from the user's mobile device (1),
wherein the service control (2) forwards the user's requests to a network-based media recorder (4), which records media data corresponding to the user's requests,
wherein at least one caching means (3) is provided, at which recorded media data is being cached and which allows forwarding of cached media data to the user's mobile device (1), and
wherein the service control (2) is further configured to receive information regarding the user's context, wherein the context information is used to control the forwarding of media data recorded by the media recorder (4) to the caching means (3).

2. The method according to claim 1, wherein the information regarding the user's context includes information regarding the user's network location and/or the user's geographic location.

3. The method according to claim 1, wherein the information regarding the user's context includes information regarding the user's intended sojourn in terms of time and location.

4. The method according to claim 1, wherein the service control (2) disposes of position based traffic information, including information regarding flight and/or train timetables, train tracks and/or traffic conditions.

5. The method according to claim 1, wherein the service control (2) is configured to receive information regarding the user's preferences and/or regarding the capabilities of the user's mobile device (1).

6. The method according to claim 1, wherein the media data requested by the user's mobile device (1) is encoded and/or transcoded before being stored by the media recorder (4).

7. The method according to claim 1, wherein the recorded media data is encoded and/or transcoded before being cached at a caching means (3).

8. The method according to claim 1, wherein media data which is cached at a caching means (3) and which is not picked up by the user's mobile device (1) is deleted after a pre-configurable time period.

9. The method according to claim 8, wherein the caching means (3) informs the service control (2) of the deletion of cached media data.

10. The method according to claim 1, wherein a plurality of caching means (3) is provided as a part of a fixed network.

11. The method according to claim 10, wherein the caching means (3) are connected to network points (8) which allow attachment of the user's mobile device (1).

12. The method according to claim 11, wherein the cached media data is forwarded to the user's mobile device (1), when the user's mobile device (1) is attached to said point (8) of attachment.

13. The method according to claim 1, wherein the caching means (3) is associated to the user's mobile device (1) in such a way that both the caching means (3) and the user's mobile device (1) perform essentially the same movements.

14. The method according to claim 1, wherein the media content requested by the user and stored by the media recorder (4) is forwarded to a caching means (3) as a single entity.

15. The method according to claim 1, wherein the media content requested by the user and stored by the media recorder (4) is forwarded to a caching means (3) in several chunks.

16. The method according to claim 15, wherein the length of the chunks is determined by the service control (2) according to the user's context information.

17. A system for delivering media data to a user's mobile device, comprising
a service control (2), which is configured to receive media content related requests from the user's mobile device (1),
a network-based media recorder (4), which is configured to receive the user's requests forwarded to it by the service control (2) and which records media data corresponding to the user's requests, and
at least one caching means (3) for the caching of recorded media data, the caching means (3) being configured to allow forwarding of cached media data to the user's mobile device (1),
wherein the service control (2) is further configured to receive information regarding the user's context and to control the forwarding of media data recorded by the media recorder (4) to the caching means (3) on the basis of said user's context information.

18. The system according to claim 17, comprising an encoder and/or transcoder (6) which is enabled to encode and/or transcode media data from one format to another.

19. The system according to claim 17, wherein the caching means (3) are part of a fixed network.

20. The system according to claim 17, wherein the caching means (3) are connected to network points (8) which allow attachment of the user's mobile device (1).

21. The system according to claim 20, wherein the network points (8) provide a high speed connection between the caching means (3) and the user's mobile device (1).

22. The system according to claim 17, wherein the caching means (3) is associated to the user's mobile device (1) in such a way that both the caching means (3) and the user's mobile device (1) perform essentially the same movements.
